(19) United States
(12) Patent Application Publication
(10) Pub. No.: US 2015/0040005 A1
(43) Pub. Date: Feb. 5, 2015

(54) MOBILE COMPUTING DEVICE CONFIGURED TO OUTPUT HAPTIC INDICATION OF TASK PROGRESS

(71) Applicant: Google Inc., Mountain View, CA (US)

(72) Inventors: Alexander Faaborg, Mountain View, CA (US); Gabriel Aaron Cohen, Alameda, CA (US)

(73) Assignee: Google Inc., Mountain View, CA (US)

(21) Appl. No.: 14/049,123

(22) Filed: Oct. 8, 2013

Related U.S. Application Data
(60) Provisional application No. 61/859,864, filed on Jul. 30, 2013.

(51) Int. Cl. G06F 3/01

(52) U.S. Cl. CPC G06F 3/016
USPC 715/702

(57) ABSTRACT

A mobile computing device can include one or more haptic devices and a haptic output module. Responsive to receiving an indication of an instruction for the mobile computing device to perform a task, the haptic output module can be operable to cause at least one haptic device of the one or more haptic devices to output, for a period of time based on a duration of the task, a haptic signal having a characteristic that indicates a progress of performance of the task by the mobile computing device.

This application claims the benefit of U.S. Provisional Application No. 61/859,864, filed Jul. 30, 2013, the entire content of which is hereby incorporated by reference.

### BACKGROUND

Some computing devices output, for display at a display device, a graphical progress indicator while performing a task (e.g., copying a file, downloading a file, or installing an application). The graphical progress indicator can include, for example, a graphical progress bar that appears to proportionately fill the graphical progress indicator as execution of the task proceeds. Other example graphical progress indicators include a graphical progress bar with a graphical indicator that appears to continually move while the computing device performs the task, or a graphical element that appears to spin or rotate while the computing device performs the task. By outputting the graphical progress indicator for display, the computing device can enable a user of the device to visually monitor the progress of a current computing task.

### SUMMARY

In one example, the disclosure describes a method that includes receiving, a computing device, an indication of user input indicating a task to be performed, and initiating, by the computing device, the task. In accordance with this example, the method also includes causing, by the computing device, at least one haptic device operatively coupled to the computing device to output, for a period of time based on a duration of the task, a haptic signal having a characteristic that indicates a progress of performance of the task.

In another example, the disclosure describes a mobile computing device including one or more processors, one or more haptic devices, a user interface module operable by the one or more processors, and a haptic output module operable by the one or more processors. In accordance with this example, the user interface module is operable by the one or more processors to receive an indication of user input indicating a task to be performed, and, responsive to the indication, cause the task to be performed. The haptic output module can be operable by the one or more processors to cause at least one haptic device of the one or more haptic devices to output, for a period of time based on a duration of the task, a haptic signal having a characteristic that indicates a progress of performance of the task. In some examples, the characteristic of the haptic signal that represents a progress of the performance of the task comprises a current location of the at least one haptic device at which the at least one haptic device outputs the haptic signal, and the haptic output module causes the at least one haptic device of the one or more haptic devices to modify the current location of the at least one haptic device at which the at least one haptic device outputs the haptic signal during the performance of the task to represent progress of the task.

In another example, the disclosure describes a computer-readable storage device storing instructions that, when executed, cause at least one processor of a mobile computing device to receive an indication of user input indicating a task to be performed and initiate the task. Additionally, the instructions can, when executed, cause the at least one processor of the mobile computing device to cause at least one haptic device associated with the mobile computing device to output, for a period of time based on a duration of the task, a haptic signal having a characteristic that indicates a progress of performance of the task, and, upon completing the task, cause the at least one haptic device to cease producing the haptic signal.

The details of one or more examples are set forth in the accompanying drawings and the description below. Other features, objects, and advantages will be apparent from the description and drawings, and from the claims.

### BRIEF DESCRIPTION OF DRAWINGS

FIGS. 1A and 1B are conceptual block diagrams illustrating example mobile computing devices that can output, for a period of time based on a duration of a task, a haptic signal having a characteristic that indicates a progress of performance of the task, in accordance with one or more techniques of the present disclosure.

FIG. 2 is a block diagram illustrating further details of one example of a mobile computing device as shown in FIG. 1A, in accordance with one or more techniques of the present disclosure.

FIG. 3 is a conceptual block diagram illustrating an example mobile computing device that outputs graphical content for display at a remote device and can output, for a period of time based on a duration of a task, a haptic signal having a characteristic that indicates a progress of performance of the task, in accordance with one or more techniques of the present disclosure.

FIG. 4 is a conceptual block diagram illustrating an example mobile computing device that can output, for a period of time based on a duration of a task, a haptic signal having a characteristic that indicates a progress of performance of the task, in accordance with one or more techniques of the present disclosure.

FIG. 5 is a conceptual block diagram illustrating an example mobile computing device that can output, for a period of time based on a duration of a task, a haptic signal having a characteristic that indicates a progress of performance of the task, in accordance with one or more techniques of the present disclosure.

FIG. 6 is a flow diagram illustrating example techniques for outputting, for a period of time based on a duration of a task, a haptic signal having a characteristic that indicates a progress of performance of the task, in accordance with one or more techniques of the present disclosure.

FIG. 7 is a conceptual block diagram illustrating an example mobile computing device that transmits, to a second computing device, an indication of an instruction of user input indicating a task to be performed.

FIG. 8 is a flow diagram illustrating example techniques for outputting, for a period of time based on a duration of a task, a haptic signal having a characteristic that indicates a progress of performance of a task, in accordance with one or more techniques of the present disclosure.

### DETAILED DESCRIPTION

Techniques according to the disclosure describe a computing device that is configured to cause at least one haptic device to output a haptic signal having a characteristic that indicates a progress of a computing task performed by the computing device or another computing device. The computing device can be configured to cause the at least one haptic device to output the haptic signal for period of time based on the duration of the task, and can cease causing the at least one haptic device to the haptic signal upon completion of the task. In some examples, the period of time based on the duration of the task may be substantially the same (e.g., the same or nearly the same) as the duration of the task. In contrast to visual indications of the progress of performance of a task, the haptic signal may be perceivable by a user directly or indirectly in contact with the at least one haptic (e.g., touching or wearing a device in which the at least one haptic device is included). In this way, the computing device can allow a user to monitor a progress of the task without looking at a display operatively coupled to the computing device.

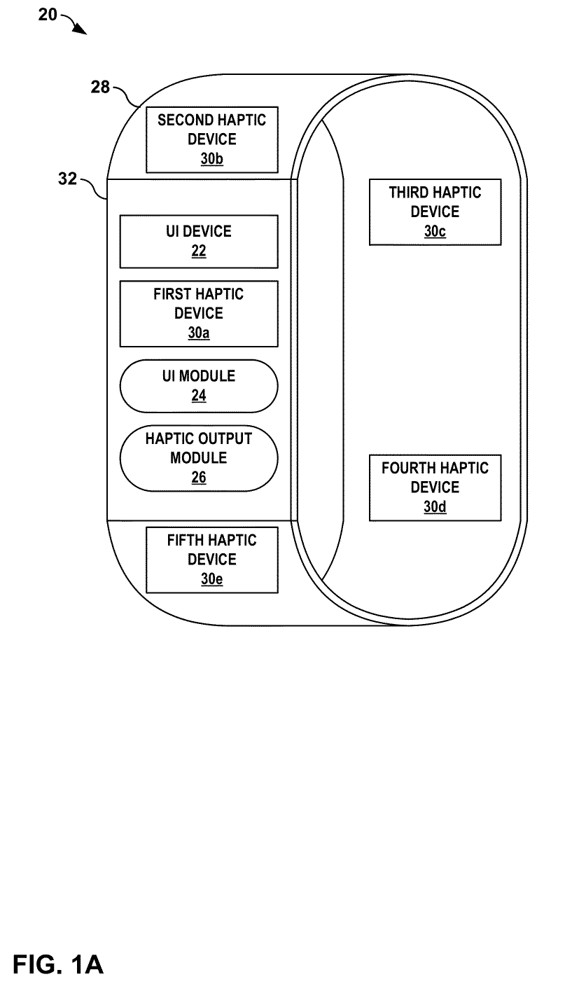

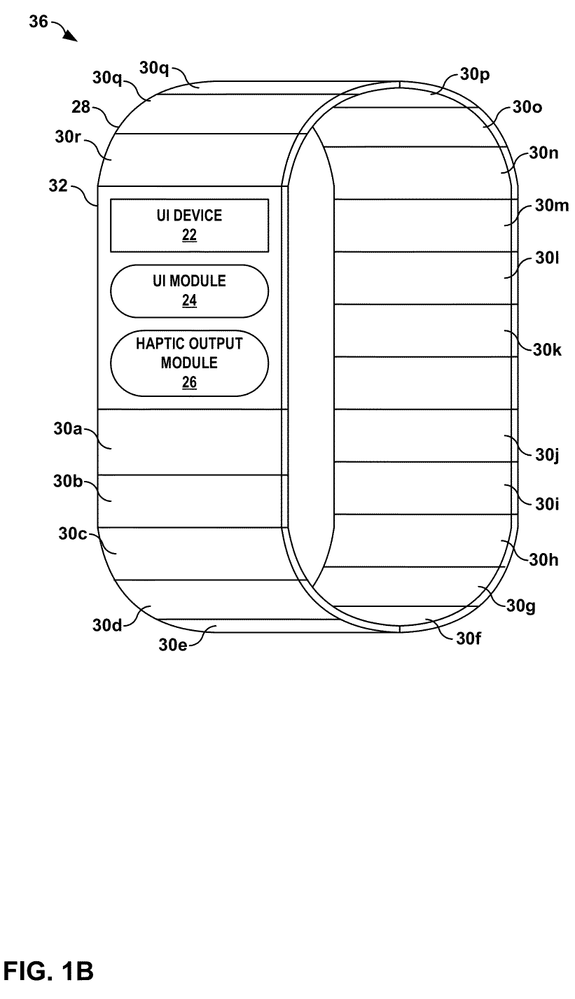

FIGS. 1A and 1B are conceptual block diagrams illustrating example mobile computing devices 20 and 36, respectively, that include at least one haptic device that can output, for a period of time based on a duration of a task, a haptic signal having a characteristic that indicates a progress of performance of the task by mobile computing device 20, in accordance with one or more techniques of the present disclosure. In the example of FIG. 1A, mobile computing device 20 includes at least one user interface (UI) device 22, a UI module 24, a haptic output module 26, and a plurality of haptic device 30a-30e (collectively, “haptic devices 30”). In some examples, UI device 22 and other electronic components of mobile computing device 20 may be at least partially enclosed by a housing 32. Additionally, mobile computing device 20 can include a band 28 or other mechanism, such as a strap or frame, for physically securing mobile computing device 20 when being worn by a user. In the example of FIG. 1A, band 28 is mechanically coupled to housing 32. In some examples, instead of band 28 and housing 32 being separate structures mechanically coupled together, band 28 and housing 32 may be a single, unitary structure. Other examples of mobile computing device 20 that implement techniques of this disclosure may include additional components not shown in FIG. 1A. Other examples of mobile computing device 20 that implement techniques of this disclosure may include additional components not shown in FIG. 1A.

Examples of mobile computing device 20 may include, but are not limited to, portable or mobile devices such as mobile phones (including smart phones), tablet computers, cameras, personal digital assistants (PDAs), etc. Other examples of mobile computing device 20 include wearable computing devices, such as, for example, a smart watch, smart glasses, etc. As shown in the example of FIG. 1A, mobile computing device 20 can be a watch, and can include or be operably coupled to a band 28.

Mobile computing device 20 can include at least one UI device 22. A user associated with mobile computing device 20 may interact with mobile computing device 20 by providing various user inputs into the mobile computing device 20, e.g., using the at least one UI device 22. In some examples, the at least one UI device 22 is configured to receive tactile, audio, or visual input. In addition to receiving input from a user, UI device 22 can be configured to output content such as a graphical user interface (GUI) for display, e.g., at a display device associated (e.g., included in) with mobile computing device 20. In some examples, UI device 22 can include a display and/or a presence-sensitive input device. In some examples, the display and the presence-sensitive input device may be integrated into a presence-sensitive display, which displays the GUI and receives input from the user using capacitive, inductive, and/or optical detection at or near the presence sensitive display. In other examples, the display device can be physically separate from a presence-sensitive device associated with (e.g., included in) mobile computing device 20.

As shown in FIG. 1A, mobile computing device 20 also can include UI module 24. UI module 24 can perform one or more functions to receive indication of input, such as user input, and send the indications of the input to other components associated with mobile computing device 20, such as haptic output module 26. For example, UI module 24 can receive an indication of a gesture performed by the user at UI device 22. UI module 24 can also receive information from components associated with mobile computing device 20, such as haptic output module 26. Using the information, UI module 24 may cause other components associated with mobile computing device 20, such as UI device 22, to provide output based on the information. For instance, UI module 24 can receive an indication of user input instructing mobile computing device 20 to perform a task and cause mobile computing device 20 to initiate the task. Additionally, UI module 24 may communicate an indication to haptic output module 26. Responsive to the indication, haptic output module 26 can control at least one haptic device of haptic devices 30 associated with (e.g., included in) mobile computing device 20 to output, for a period of time based on a duration of the task, a haptic signal having a characteristic that indicates a progress of performance of the task. For example, haptic output module 26 may output one or more electrical signals (e.g., analog or digital signals) that causes haptic device 30 to output the haptic signal. Haptic output module 26 may output, by way of an output port coupled to a digital-to-analog converter, analog signals to haptic devices 30 so as to drive the haptic devices 30 with electrical energy to produce the computed haptic signal. As another example, haptic devices 30 may be programmatic components responsive to signals in the form of simple commands.

UI module 24 may be implemented in various ways. For example, UI module 24 can be implemented as a downloadable or pre-installed application or “app.” In another example, UI module 24 can be implemented as part of a hardware unit of mobile computing device 20. In another example, UI module 24 can be implemented as part of an operating system of mobile computing device 20.

Mobile computing device 20 can also include haptic output module 26. Haptic output module 26 can be implemented in various ways. For example, haptic output module 26 can be implemented as a downloadable or pre-installed application or “app.” In other examples, haptic output module 26 can be implemented as part of a hardware unit of mobile computing device 20 or as part of an operating system of mobile computing device 20.

Additionally, mobile computing device 20 can be associated with a plurality of haptic devices 30a-30e (collectively, “haptic devices 30”). For example, as shown in FIG. 1A, mobile computing device 20 includes five haptic devices 30a-30e. Haptic devices 30 are thus associated with mobile computing device 20. In other examples, haptic devices 30 may not be included in mobile computing device 20, but nevertheless may be associated with mobile computing device 20, e.g., through a wired or wireless communication link.

Although in the example of FIG. 1A mobile computing device 20 includes five haptic devices 30a-30e, in other examples, mobile computing device 20 can include fewer than five haptic devices 30a-30e or more than haptic devices 30a-30e. Generally, mobile computing device 20 can be associated with (e.g., include) one or more haptic devices 30, e.g., mobile computing device 20 can include a single haptic device 30 or at least one haptic device 30. For example, as shown in FIG. 1B, computing device 36 is associated with (e.g., includes) a plurality of haptic devices 30a-30r. Haptic devices 30 are disposed at different locations of band 28. In the example shown in FIG. 1B, haptic devices 30 are disposed at locations spaced along substantially an entire length band 28.

Haptic devices 30 can include any device that is operable to produce a tangible effect that can be felt by a user in contact with at least a portion of mobile computing device 20 (including band 28). For example, haptic devices 30 can include any one or more of an electromagnetic motor, an eccentric motor, an electroactive polymer, a piezoelectric device, etc., which may produce a haptic effect for the user, e.g., a vibration. As another example, haptic devices 30 can include one or more electrodes through which a very low intensity electric current is passed, which can produce a slight sensation when the electrodes are in contact with a user's skin, e.g., when mobile computing device 20 includes a wearable computing device. As an additional example, haptic devices 30 can include a muscle wire or shape-memory alloy, which can reversibly change from one phase shape to another in response to changes in temperature, e.g., caused by application and removal of electric current to the shape-memory alloy.

In accordance with one or more aspect of the disclosure, mobile computing device 20 can be configured to output a haptic signal having a characteristic that indicates a progress of performance of a computing task. In some examples, UI module 24 can receive an indication of user input instructing mobile computing device 20 to perform a task and cause mobile computing device 20 to initiate the task. Additionally, UI module 24 can communicate an indication to haptic output module 26. Responsive to the indication, haptic output module 26 can cause at least one haptic device of haptic device(s) 30 to output, for a period of time based on a duration of the task, a haptic signal having a characteristic that indicates a progress of performance of the task by mobile computing device 20. For example, haptic output module 26 can output a signal or instruction to at least one haptic device of haptic device(s) 30 to output the haptic signal.

The characteristic of the haptic signal can include, for example, a location of the at least one haptic device at which haptic devices 30 output the haptic signal. For example, as shown in FIGS. 1A and 1B, haptic devices 30 can be spaced about mobile computing device 20, e.g., at locations on or within band 28 and/or housing 32. Haptic output module 26 can control the location of mobile computing device 20 at which the haptic signal originates by controlling which one or more of haptic devices 30 outputs the haptic signal. For example, if haptic output module 26 causes third haptic device 30c to generate a haptic signal, and does not cause the other haptic devices 30a, 30b, 30d, and 30e to generate a haptic signal (or outputs an instruction to the other haptic devices 30a, 30b, 30d, and 30e to not generate a haptic signal), a user of mobile computing device 20 may perceive the haptic signal as coming from the region of band 28 at which third haptic device 30c is located.

Haptic output module 26 can simultaneously control one or more of haptic devices 30 to generate a haptic signal, and can, over time, change the haptic devices 30 which the haptic output module 26 causes to generate a haptic signal. By changing over time the haptic devices 30 that are outputting a haptic signal, haptic output module 26 may cause the location at which one or more of haptic devices 30 output the haptic signal to change along mobile computing device 20. The changing location at which one or more of haptic devices 30 output the haptic signal can indicate the progress of performance of the task by mobile computing device 20 (i.e., can be a haptic progress indicator).

In other examples, the characteristic of the haptic signal can include an intensity, frequency, or pulse duration of the haptic signal, in addition to or as an alternative to the location at which the haptic signal is produced. In some of these examples, mobile computing device 20 can include a single haptic device instead of a plurality of haptic devices 30. In other of these examples, mobile computing device 20 can include a plurality of haptic devices 30. In some implementations, haptic output module 26 can cause haptic devices 30 to modify two or more characteristics of the haptic signal (e.g., location and intensity, etc.) simultaneously to represent progress of performance of the task by mobile computing device 20.

In some implementations, the haptic progress indicator may be an indeterminate progress indicator, where haptic output module 26 causes haptic devices 30 to modify the characteristic of the haptic signal substantially continuously from the time at which mobile computing device 20 initiates the task until the time at which the task is completed. Completion of the task is indicated by cessation of the haptic signal, and the characteristics of the haptic signal do not directly correlate to progress of the performance of the task, e.g., in a 1:1 correspondence. An indeterminate haptic progress indicator indicates that performance of the computing task is progressing, but does not indicate a percentage of progress of the task. As an example, haptic output module 26 can output an indeterminate haptic progress indicator by causing the location at which haptic devices 30 output the haptic signal to change substantially continuously during performance of the task, e.g., in a single direction around band 28 (from first haptic device 30a to second haptic device 30b to third haptic device 30c, etc., or vice versa) or in a repeating sequence (e.g., from first haptic device 30a to second haptic device 30b to third haptic device 30c to fourth haptic device 30d to fifth haptic device 30e to fourth haptic device 30d to third haptic device 30c to second haptic device 30b to first haptic device 30a, etc.). As another example, haptic output module 26 can output an indeterminate haptic progress indicator by causing intensity, frequency and/or pulse duration to pulse, e.g., periodically increase and decrease in magnitude during performance of the task by mobile computing device 20.

In other examples, the haptic progress indicator may be a determinate progress indicator, where one or more characteristics of the haptic signal indicate relative progress of the performance of the task by mobile computing device 20 is indicated by. As an example, haptic output module 26 can output a determinate haptic progress indicator by causing the location at which haptic devices 30 output the haptic signal to change substantially continuously in a single direction around band 28 from a defined starting location (when mobile computing device 20 initiates the task) to a defined ending location (when mobile computing device 20 completes the task). For example, first haptic device 30a outputting the haptic signal may indicate that mobile computing device 20 recently initiated the task. As performance of the task progresses, haptic output module 26 can cause first haptic device 30a to cease outputting the haptic signal and second haptic device 30b to begin outputting the haptic signal, e.g., in an overlapping manner so the location at which the haptic signal is output appears to move from the location of first haptic device 30a to the location of second haptic device 30b. As performance of the task progresses, haptic output module 26 can cause second haptic device 30b to cease outputting the haptic signal and third haptic device 30c to begin outputting the haptic signal, then cause third haptic device 30c to cease outputting the haptic signal and fourth haptic device 30d to begin outputting the haptic signal, then cause fourth haptic device 30d to cease outputting the haptic signal and fifth haptic device 30e to begin outputting the haptic signal. Finally, as the task is completed, haptic output module 26 can cause fifth haptic device 30e to cease outputting the haptic signal and first haptic device 30a to begin outputting the haptic signal. In this way, movement of the haptic signal around band 28 indicates relative progress of performance of the task by mobile computing device 20. In other examples, haptic output module 26 can cause the apparent location at which haptic devices 30 output the haptic signal to change around a portion of band 28 (instead of the entire circumference of band 28) as mobile computing device 20 progresses in performing the task.

Other examples of a determinate haptic progress indicator are also contemplated. For example, haptic output module 26 can cause one or more of haptic devices 30 to output the haptic signal as a series of pulses. As mobile computing device 20 progresses in performing the task, haptic output module 26 can cause the pulses to be output more quickly, e.g., with less time between each pulse, until, as mobile computing device 20 completes the task, haptic output module 26 causes the one or more of haptic devices 30 to output a single haptic pulse with a longer duration, e.g., equal to a cumulative duration of multiple pulses, which indicates that mobile computing device 20 has completed the task.

Regardless of whether the haptic progress indicator is determinate or indeterminate, the haptic progress indicator may allow a user to monitor a progress of the task being performed by mobile computing device 20 without looking at a display operatively coupled to or included in mobile computing device 20. This may allow the user to continue with other activities or tasks without focusing his or her attention on mobile computing device 20, and may reduce the distraction and/or inconvenience that mobile computing device 20 causes to the user.

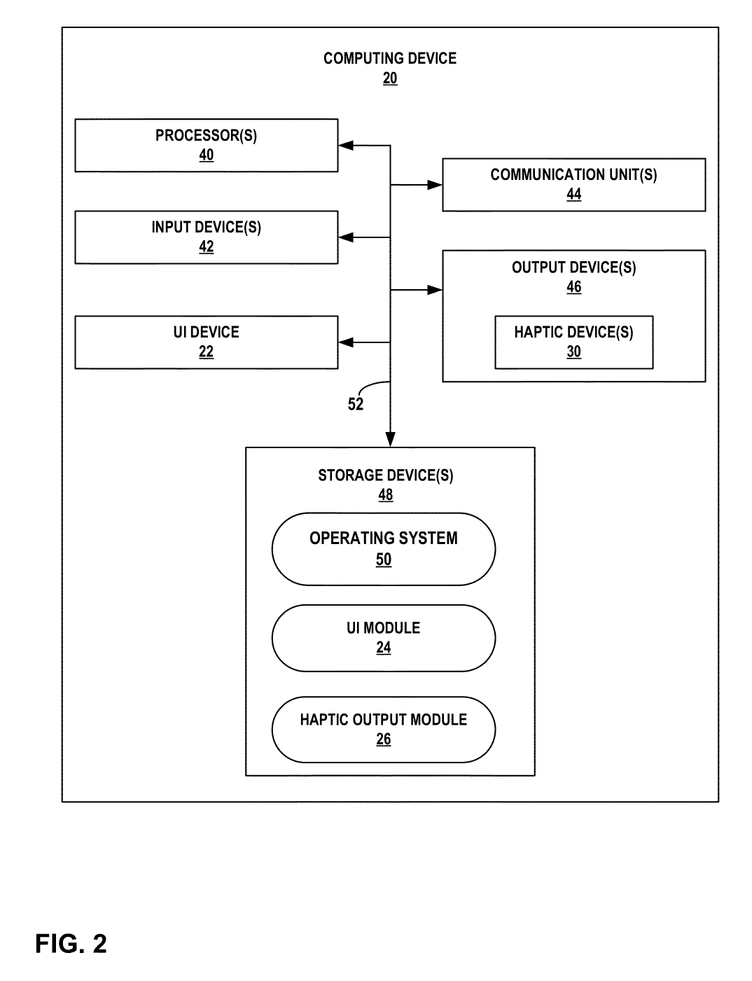

FIG. 2 is a block diagram illustrating further details of one example of a mobile computing device shown in FIG. 1A, in accordance with one or more techniques of the present disclosure. FIG. 2 illustrates only one particular example of mobile computing device 20 as shown in FIG. 1A, and many other examples of mobile computing device 20 may be used in other instances.

As shown in the example of FIG. 2, mobile computing device 20 includes one or more processors 40, one or more input devices 42, one or more communication units 44, one or more output devices 46, which can include the one or more haptic devices 30, one or more storage devices 48, and user interface (UI) device 22. In the example of FIG. 2, mobile computing device 20 further includes UI module 24, haptic output module 26, and operating system 50, which are executable by one or more processors 40. Each of components 22, 30, 40, 42, 44, 46, and 48 are coupled (physically, communicatively, and/or operatively) using communication channels 52 for inter-component communications. In some examples, communication channels 52 may include a system bus, a network connection, an inter-process communication data structure, or any other method for communicating data. UI module 24, haptic output module 26, and operating system 50 may also communicate information with one another, as well as with other components in mobile computing device 20.

One or more processors 40, in one example, are configured to implement functionality and/or process instructions for execution within mobile computing device 20. For example, processors 40 may be capable of processing instructions stored by storage device 48. Examples of one or more processors 40 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 48 may be configured to store information within mobile computing device 20 during operation. Storage devices 48, in some examples, include a computer-readable storage medium or computer-readable storage device. In some examples, storage devices 48 include a temporary memory, meaning that a primary purpose of storage device 48 is not long-term storage. Storage devices 48, in some examples, include a volatile memory, meaning that storage device 48 does not maintain stored contents when power is not provided to storage device 48. Examples of volatile memories include random access memories (RAM), dynamic random access memories (DRAM), static random access memories (SRAM), and other forms of volatile memories known in the art. In some examples, storage devices 48 are used to store program instructions for execution by processors 40. Storage devices 48, in some examples, are used by software or applications running on mobile computing device 20 (e.g., haptic output module 26) to temporarily store information during program execution.

In some examples, storage devices 48 may further include one or more storage device 48 configured for longer-term storage of information. In some examples, storage devices 48 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Mobile computing device 20, in some examples, also includes one or more communication units 44. Mobile computing device 20, in one example, utilizes communication unit 44 to communicate with external devices via one or more networks, such as one or more wireless networks. Communication unit 44 may be a network interface card, such as an Ethernet card, an optical transceiver, a radio frequency transceiver, or any other type of device that can send and receive information. Other examples of such network interfaces may include Bluetooth, 3G, and WiFi radios, as well as Universal Serial Bus (USB). In some examples, mobile computing device 20 utilizes communication unit 44 to wirelessly communicate with an external device such as a server.

Mobile computing device 20, in one example, also includes one or more input devices 42. Input device 42, in some examples, is configured to receive input from a user through tactile, audio, or video sources. Examples of input device 42 include a presence-sensitive device, such as a presence-sensitive display, a mouse, a keyboard, a voice responsive system, video camera, microphone or any other type of device for detecting a command from a user. In some examples, a presence-sensitive display includes a touch-sensitive display.

One or more output devices 46 may also be included in mobile computing device 20. Output devices 46, in some examples, are configured to provide output to a user using tactile, audio, or video stimuli. For example, output devices 46 can include one or more haptic devices 30, which can be located within or attached to an exterior of housing 32 (FIG. 1A) of mobile computing device 20 and/or at one or more locations of band 28. Output devices 46 can also include, for example, a presence-sensitive display, a sound card, a video graphics adapter card, or any other type of device for converting a signal into an appropriate form understandable to humans or machines. Additional examples of output devices 46 include a speaker, a cathode ray tube (CRT) monitor, a liquid crystal display (LCD), organic light emitting diode (OLED), or any other type of device that can generate intelligible output to a user. In some examples, UI device 22 may include functionality of one or more of input devices 42 and/or output devices 46.

Mobile computing device 20 also can include UI device 22. In some examples, UI device 22 is configured to receive tactile, audio, or visual input. In addition to receiving input from a user, UI device 22 can be configured to output content such as a GUI for display at a display device, such as a presence-sensitive display. In some examples, UI device 22 can include a presence-sensitive display that displays a GUI and receives input from a user using capacitive, inductive, and/or optical detection at or near the presence sensitive display. In some examples, UI device 22 is both one of input devices 44 and one of output devices 46.

In some examples, UI device 22 of mobile computing device 20 may include functionality of input devices 42 and/or output devices 46. In some examples, a presence-sensitive device may detect an object at and/or near the presence-sensitive device. As one example range, a presence-sensitive device may detect an object, such as a finger or stylus, which is within two inches or less of the presence-sensitive device. The presence-sensitive device may determine a location (e.g., an (x,y) coordinate) of the presence-sensitive device at which the object was detected. In another example range, a presence-sensitive device may detect an object six inches or less from the presence-sensitive device. Other example ranges are also possible. The presence-sensitive device may determine the location of the device selected by the object using, for example, capacitive, inductive, and/or optical recognition techniques. In some examples, the presence-sensitive device provides output to a user using tactile, audio, or video stimuli as described with respect to output device 46.

Mobile computing device 20 may include operating system 50. Operating system 50, in some examples, controls the operation of components of mobile computing device 20. For example, operating system 50, in one example, facilitates the communication of UI module 24 and haptic output module 26 with processors 40, communication units 44, storage devices 48, input devices 42, and output devices 46. UI module 24 and haptic output module 26 can each include program instructions and/or data that are executable by mobile computing device 20 (e.g., by one or more processors 40). As one example, UI module 24 can include instructions that cause mobile computing device 20 to perform one or more of the operations and actions described in the present disclosure.

Mobile computing device 20 can include additional components that, for clarity, are not shown in FIG. 2. For example, mobile computing device 20 can include a battery to provide power to the components of mobile computing device 20. Similarly, the components of mobile computing device 20 shown in FIG. 2 may not be necessary in every example of mobile computing device 20. For example, in some configurations, mobile computing device 20 may not include communication unit 44.

In accordance with one or more aspects of the disclosure, mobile computing device 20 can be configured to output a haptic signal having a characteristic that indicates a progress of performance of a task, e.g., by one or more processors 40. For example, UI module 24 can receive an indication of a user input, e.g., at one or more input devices 42 and/or UI device 22, instructing one or more processors 40 to perform a task. The task may include any task which one or more processors 40 can be configured to perform, e.g., based at least in part on instructions associated with operating system 50 and/or one or more applications executed by one or more processors 40, or may a task to be performed by a second, different computing device. For example, the task may include performing an internet search; sending a message, such as an email, short message service (SMS) message, multimedia service (MMS) message, instant message, social network message, or the like; transcribing voice input to text; retrieving directions using a navigation or mapping application; executing a voice command; etc.

Responsive to receiving the indication of the user input, UI module 24 can cause one or more processors 40 to initiate the task. Additionally, UI module 24 can communicate an indication to haptic output module 26. Responsive to the indication, haptic output module 26 can cause at least one haptic device of haptic device(s) 30 associated with computing device 20 to output, for a period of time based on a duration of the task, a haptic signal having a characteristic that indicates a progress of performance of the task by one or more processors 40. For example, haptic output module 26 can output an instruction (e.g., an electrical signal, command, parameter via memory mapped I/O, or the like), to at least one haptic device of haptic device(s) 30 associated with computing device 20 to output, for a period of time based on a duration of the task, the haptic signal.

The characteristic of the haptic signal can include, for example, a location of the at least one haptic device(s) 30 at which one or more of haptic devices 30 outputs the haptic signal, an intensity of the haptic signal, a pulse duration of the haptic signal, a frequency of the haptic signal, or the like. As haptic device(s) can be distributed at different locations within mobile computing device 20 (including band 28), the apparent location at which the haptic signal is originating within or on mobile computing device 20 may change as the location of the at least one haptic device(s) 30 at which one or more of haptic devices 30 outputs the haptic signal changes. By changing the characteristic of the haptic signal, progress of performance of the task by one or more processors 40 can be represented.

Haptic device(s) 30 can include, for example, any one or more of an electromagnetic motor, an eccentric motor, an electroactive polymer, a piezoelectric device, an electrode pair through which a very low intensity electric current is passed, a muscle wire, a shape-memory alloy, a fluid-filled flexible container that can deform in response to an applied pressure, or any other mechanism that can output an effect that a user in contact with mobile computing device 20 can perceive, e.g., using touch. In this way, the user can perceive the haptic signal, and, thus, progress of performance of the task by one or more processors 40, without looking at a display device included in or associated with mobile computing device 20.

In some examples, in addition to communicating the indication of the task to haptic output module 26, UI module 24 can also output, for display at a display device associated with or included in mobile computing device 20, a visual progress indicator. The visual progress indicator can include, for example, a progress bar that appears to fill in proportion to the progress of the task, a progress bar with an indicator that appears to continually move while the computing device performs the task, or a graphical element that appears to spin or rotate while one or more processors 40 performs the task. By outputting the progress indicator for display, UI module 24 enables a user of mobile computing device 20 to visually monitor the progress of the task one or more processors 40 is performing, along with perceiving the progress of performance of the task using the haptic signal.

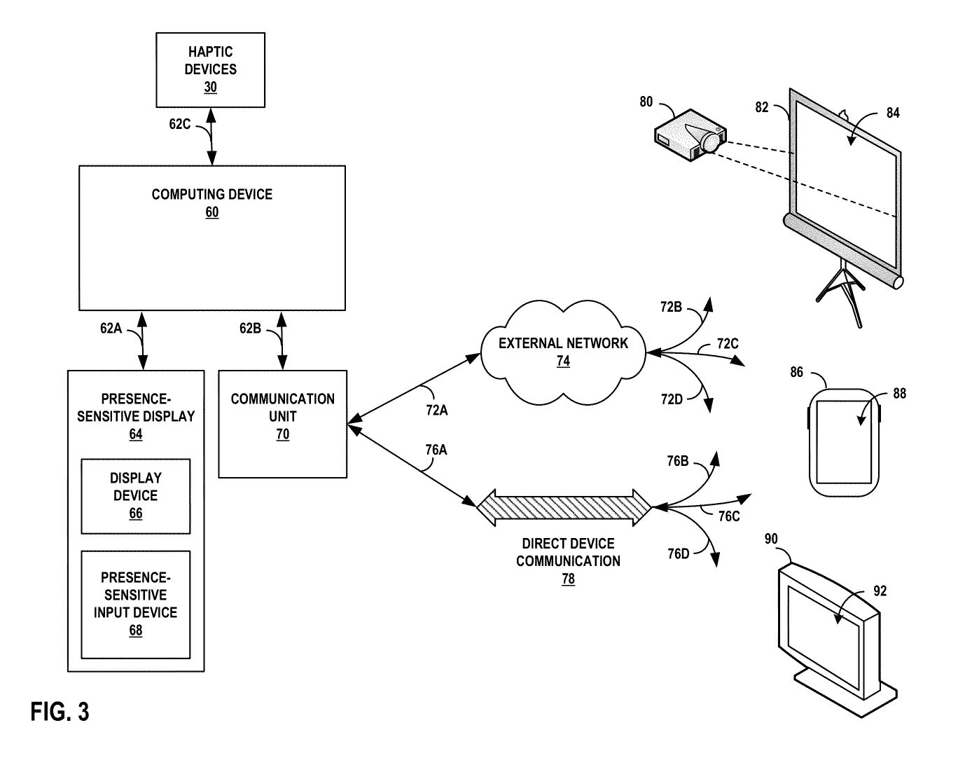

FIG. 3 is a conceptual block diagram illustrating an example mobile computing device that outputs graphical content for display at a remote device and can output, for a period of time based on a duration of a task, a haptic signal having a characteristic that indicates a progress of performance of the task by the mobile computing device, in accordance with one or more techniques of the present disclosure. Graphical content, generally, may include any visual information that may be output for display, such as text, images, a group of moving images, etc. The example shown in FIG. 3 includes a computing device 60, presence-sensitive display 64, communication unit 70, projector 80, projector screen 82, mobile device 86, and visual display device 90. Although shown for purposes of example in FIGS. 1A and 2 as a stand-alone mobile computing device 20, a computing device such as computing device 60 may, generally, be any component or system that includes a processor or other suitable computing environment for executing software instructions and, for example, need not include a presence-sensitive display.

As shown in the example of FIG. 3, computing device 60 may be a processor that includes functionality as described with respect to processors 40 in FIG. 2. In some such examples, computing device 60 may be operatively coupled to presence-sensitive display 64 by a communication channel 62A, which may be a system bus or other suitable connection. Computing device 60 may also be operatively coupled to communication unit 70, further described below, by a communication channel 62B, which may also be a system bus or other suitable connection. Although shown separately as an example in FIG. 3, computing device 60 may be operatively coupled to presence-sensitive display 64 and communication unit 70 by any number of one or more communication channels.

In other examples, such as illustrated previously by mobile computing device 20 in FIGS. 1A and 2, a computing device may refer to a portable or mobile device such as mobile phones (including smart phones), laptop computers, wearable computing devices such as smart watches or smart glasses, etc. In some examples, a computing device may be a desktop computer, tablet computer, smart television platform, camera, personal digital assistant (PDA), server, mainframe, etc.

Presence-sensitive display 64 may include display device 66 and presence-sensitive input device 68. Display device 66 may, for example, receive data from computing device 60 and display the graphical content. In some examples, presence-sensitive input device 68 may determine one or more user inputs (e.g., continuous gestures, multi-touch gestures, single-touch gestures, etc.) at presence-sensitive display 64 using capacitive, inductive, and/or optical recognition techniques and send indications of such user input to computing device 60 using communication channel 62A. In some examples, presence-sensitive input device 68 may be physically positioned on top of display device 66 such that, when a user positions an input unit over a graphical element displayed by display device 66, the location at which presence-sensitive input device 68 corresponds to the location of display device 66 at which the graphical element is displayed. In other examples, presence-sensitive input device 68 may be positioned physically apart from display device 66, and locations of presence-sensitive input device 68 may correspond to locations of display device 66, such that input can be made at presence-sensitive input device 68 for interacting with graphical elements displayed at corresponding locations of display device 66.

As shown in FIG. 3, computing device 60 may also include and/or be operatively coupled with communication unit 70. Communication unit 70 may include functionality of communication unit 44 as described in FIG. 2. Examples of communication unit 70 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 60 may also include and/or be operatively coupled with one or more other devices, e.g., input devices, output devices, memory, storage devices, etc. that are not shown in FIG. 3 for purposes of brevity and illustration.

FIG. 3 also illustrates a projector 80 and projector screen 82. Other examples of projection devices may include electronic whiteboards, holographic display devices, and any other suitable devices for displaying graphical content. Projector 80 and projector screen 82 may include one or more communication units that enable the respective devices to communicate with computing device 60. In some examples, the one or more communication units may enable communication between projector 80 and projector screen 82. Projector 80 may receive data from computing device 60 that includes graphical content. Projector 80, in response to receiving the data, may project the graphical content onto projector screen 82. In some examples, projector 80 may determine one or more user inputs (e.g., continuous gestures, multi-touch gestures, single-touch gestures, double-bezel gestures, etc.) at projector screen using optical recognition or other suitable techniques and send indications of such user input using one or more communication units to computing device 60. In such examples, projector screen 82 may be unnecessary, and projector 80 may project graphical content on any suitable medium and detect one or more user inputs using optical recognition or other such suitable techniques.

Projector screen 82, in some examples, may include a presence-sensitive display 84. Presence-sensitive display 84 may include a subset of functionality or all of the functionality of UI device 22 as described in this disclosure. In some examples, presence-sensitive display 84 may include additional functionality. Projector screen 82 (e.g., an electronic whiteboard), may receive data from computing device 60 and display the graphical content. In some examples, presence-sensitive display 84 may determine one or more user inputs (e.g., continuous gestures, multi-touch gestures, single-touch gestures, double-bezel gestures, etc.) at projector screen 82 using capacitive, inductive, and/or optical recognition techniques and send indications of such user input using one or more communication units to computing device 60.

FIG. 3 also illustrates mobile device 86 and visual display device 90. Mobile device 86 and visual display device 90 may each include computing and connectivity capabilities. Examples of mobile device 86 may include e-reader devices, convertible notebook devices, hybrid slate devices, etc. Examples of visual display device 90 may include other semi-stationary devices such as televisions, computer monitors, etc. As shown in FIG. 3, mobile device 86 may include a presence-sensitive display 88. Visual display device 90 may include a presence-sensitive display 92. Presence-sensitive display 92, for example, may receive data from computing device 60 and display the graphical content. In some examples, presence-sensitive display 92 may determine one or more user inputs (e.g., continuous gestures, multi-touch gestures, single-touch gestures, double-bezel gestures, etc.) at projector screen using capacitive, inductive, and/or optical recognition techniques and send indications of such user input using one or more communication units to computing device 60.

As described above, in some examples, computing device 60 may output graphical content for display at presence-sensitive display 64, which is coupled to computing device 60 by a system bus or other suitable communication channel. Computing device 60 may also output graphical content for display at one or more remote devices, such as projector 80, projector screen 82, mobile device 86, and visual display device 90. For instance, computing device 60 may execute one or more instructions to generate and/or modify graphical content in accordance with techniques of the present disclosure. Computing device 60 may output the data that includes the graphical content to a communication unit of computing device 60, such as communication unit 70. Communication unit 70 may send the data to one or more of the remote devices, such as projector 80, projector screen 82, mobile device 86, and/or visual display device 90. In this way, computing device 60 may output the graphical content for display at one or more of the remote devices. In some examples, one or more of the remote devices may output the graphical content at a display device, such as a presence-sensitive display, that is included in and/or operatively coupled to the respective remote device.

In some examples, computing device 60 may not output graphical content at presence-sensitive display 64 that is operatively coupled to computing device 60. In other examples, computing device 60 may output graphical content for display at both a presence-sensitive display 64 that is coupled to computing device 60 by communication channel 62A, and at a display of one or more the remote devices. In such examples, the graphical content may be displayed substantially contemporaneously at each respective device. For instance, some delay may be introduced by the communication latency to send the data that includes the graphical content to the remote device. In some examples, graphical content generated by computing device 60 and output for display at presence-sensitive display 64 may be different than graphical content display output for display at one or more remote devices.

Computing device 60 may send and receive data using any suitable communication techniques. For example, computing device 60 may be operatively coupled to external network 74 using network link 72A. Each of the remote devices illustrated in FIG. 3 may be operatively coupled to network external network 74 by one of respective network links 72B, 72C, and 72D. External network 74 may include network hubs, network switches, network routers, etc., that are operatively inter-coupled thereby providing for the exchange of information between computing device 60 and the remote devices illustrated in FIG. 3. In some examples, network links 72A-72D may be Ethernet, ATM or other network connections. Such connections may be wireless and/or wired connections.

In some examples, computing device 60 may be operatively coupled to one or more of the remote devices included in FIG. 3 using direct device communication 78. Direct device communication 78 may include communications through which computing device 60 sends and receives data directly with a remote device, using wired or wireless communication. That is, in some examples of direct device communication 78, data sent by computing device 60 may not be forwarded by one or more additional devices before being received at the remote device, and vice-versa. Examples of direct device communication 78 may include Bluetooth, Near-Field Communication, Universal Serial Bus, infrared, etc. One or more of the remote devices illustrated in FIG. 3 may be operatively coupled with computing device 60 by communication links 76A-76D. In some examples, communication links 76A-76D may be connections using Bluetooth, Near-Field Communication, Universal Serial Bus, infrared, etc. Such connections may be wireless and/or wired connections.

In accordance with one or more aspects of the disclosure, computing device 60 can be operatively coupled to one or more haptic devices 30 by communication channel 62C. Computing device 60 can be configured to cause one or more haptic devices 30 to output a haptic signal having a characteristic that indicates a progress of performance of a task by computing device 60 or another computing device with which computing device 60 is communicatively coupled. For example, computing device 60 can receive an indication of a user input, e.g., at one or more of presence sensitive displays 64, 84, 88, and 92, instructing computing device 60 to perform a task. In some examples, the task may include any task which computing device 60 can be configured to perform, e.g., based at least in part on instructions associated with an operating system and/or one or more applications executed by computing device 60. In other examples, the task may include any task than can be performed by a computing device communicatively coupled to computing device 60, e.g., a remote computing device such as a content server. The user input may or may not indicate which computing device (e.g., computing device 60 or the other computing device) is to perform the task.

Responsive to receiving the indication of the user input, computing device 60 can initiate the task. Additionally, computing device 60 can cause at least one haptic device of haptic device(s) 30 to output, for a period of time based on a duration of the task, a haptic signal having a characteristic that indicates a progress of performance of the task by computing device 60. The characteristic of the haptic signal can include, for example, a location of at least one of haptic devices 30 at which one or more of haptic devices 30 outputs the haptic signal, an intensity of the haptic signal, a pulse duration of the haptic signal, a frequency of the haptic signal, or the like. By changing the characteristic of the haptic signal, progress of performance of the task can be represented.

In some examples, in addition to communicating the indication of the task to haptic output module 26, UI module 24 can also output, for display at a one or more of presence-sensitive displays 64, 84, 88, and 92, a visual progress indicator. The visual progress indicator can include, for example, a progress bar that appears to fill in proportion to the progress of the task, a progress bar with an indicator that appears to continually move while the computing device performs the task, or a graphical element that appears to spin or rotate while one or more processors 40 performs the task. By outputting the progress indicator for display, UI module 24 enables a user of mobile computing device 20 to visually monitor the progress of the task one or more processors 40 is performing, along with perceiving the progress of performance of the task using the haptic signal.

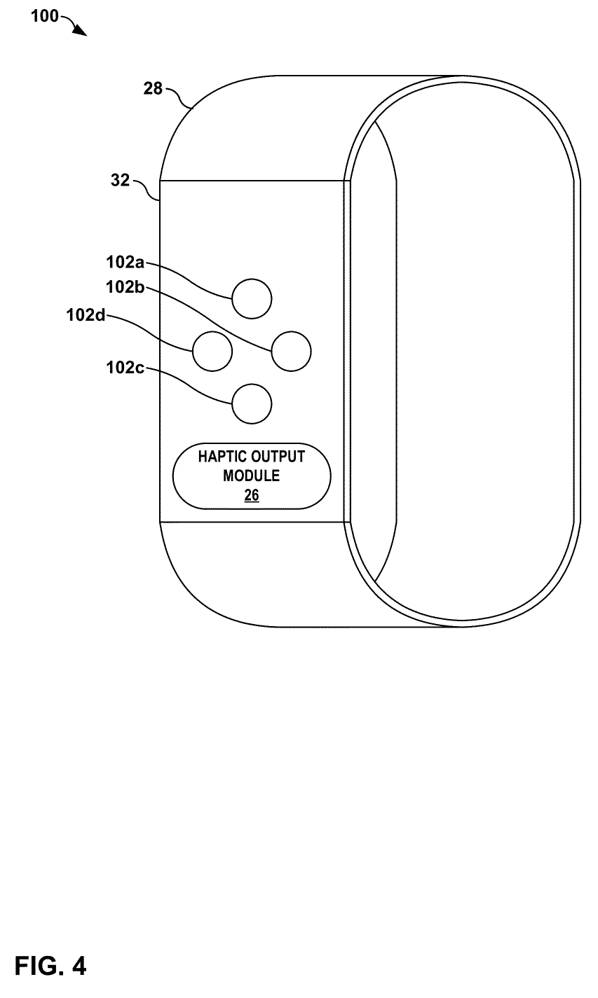

FIG. 4 is a conceptual block diagram illustrating an example mobile computing device 100 that can output, for a period of time based on a duration of a task, a haptic signal having a characteristic that indicates a progress of performance of the task by the mobile computing device 100, in accordance with one or more techniques of the present disclosure. FIG. 4 illustrates a simplified representation of mobile computing device 100, and omits some components of mobile computing device 100 for clarity. In some examples, mobile computing device 100 can include components similar to those described with reference to mobile computing device 20 of FIGS. 1A and 2. In other examples, mobile computing device 100 can include more or fewer components that mobile computing device 20.

As shown in FIG. 4, mobile computing device 100 includes haptic output module 26, housing 32, band 28, and four haptic devices 102a-102d (collectively, “haptic devices 102”). In the example of FIG. 4, haptic devices 102 are disposed within or attached to a surface of housing 32 facing the user when the user is wearing mobile computing device 100. In other examples, one or more of haptic devices 102 can be disposed within or attached to a surface of band 28 that faces the user when the user is wearing mobile computing device 100.

Haptic devices 102 are disposed in a diamond-shaped configuration in the example of FIG. 4. As described above, haptic output module 26 can be operable to receive an indication of an input by a user, e.g., using an input device associated with or included in mobile computing device 100, instructing mobile computing device 100 to perform a task. Responsive to receiving the indication, haptic output module 26 can be operable to cause one or more of haptic devices 102 to output a haptic signal. The haptic signal can include a characteristic that indicates a progress of performance of the task by mobile computing device 100. For example, the characteristic can include a location of haptic devices 102 at which one or more of haptic devices 102 outputs the haptic signal. As haptic device(s) 102 can be distributed at different locations within mobile computing device 100, the apparent location at which the haptic signal is originating within or on mobile computing device 100 may change as the location of the at least one haptic device(s) 102 at which one or more of haptic devices 102 outputs the haptic signal changes.

In some examples, the haptic signal may include a determinate haptic progress indicator. As described above, change of the characteristic indicative of progress of the task for a determinate haptic progress indicator also indicates an extent of progress of the task. For example, responsive to receiving an indication that mobile computing device 100 is initiating the task, haptic output module 26 can cause first haptic device 102a to output a haptic signal. As performance of the task progresses, haptic output module 26 may receive periodic indications of the status of the progress. Responsive to receiving the periodic indication of the status of the progress, haptic output module 26 can cause different ones of one or more haptic devices 102 to output the haptic signal, which causes the location at which the haptic signal is output to change. For example, as haptic output module 26 receives indications of progress of the task between 0% and 25% of the task, haptic output module 26 can cause the intensity with which first haptic output device 102a outputs the haptic signal to decrease, while causing the intensity with which second haptic output device 102b outputs the haptic signal to increase. In some examples, haptic output module 26 can also cause the total intensity with which first and second haptic devices 102a and 102b output the haptic signal to remain substantially constant (e.g., constant or nearly constant). This may cause the location at which the haptic signal is output to appear to change substantially continuously between the location of first haptic device 102a and second haptic device 102b.

Haptic output module 26 can be operable to cause second haptic device 102b and third haptic device 102c to change intensity of haptic signals generated by second haptic device 102b and third haptic device 102c responsive to receiving indications of progress of the task between 25% and 50%. This may cause the location at which the haptic signal is output to appear to change substantially continuously between the location of second haptic device 102b and third haptic device 102c. A similar technique can be performed by haptic output module 26 responsive to receiving indications of progress of the task between 50% and 75% (causing third haptic device 102c and fourth haptic device 102d to change intensity of haptic signals) and responsive to receiving indications of progress of the task between 75% and 100% (causing fourth haptic device 102d and first haptic device 102a to change intensity of haptic signals). In this way, performance of the task progresses from 0% to 100%, the location at which the haptic signal is output by haptic devices 102 can change in a manner that completes a diamond shape (approximating a circle with four haptic devices 102). Additionally, the movement of the haptic signal around the diamond shape correlates to progress of the task.

In other examples, the haptic signal may include an indeterminate haptic progress indicator. As described above, change of the characteristic indicative of progress of the task for an indeterminate haptic progress indicator does not correlate to an extent of progress of the task, but movement of the haptic progress indicator indicates that mobile computing device 100 is performing the task. For example, responsive to receiving an indication that mobile computing device 100 is initiating the task, haptic output module 26 can cause haptic devices 102 to individually and in a synchronized manner increase and decrease an intensity of the haptic signal generated by the respective haptic device 102a-102d. As described above with respect to the determinate haptic progress indicator, if timed properly, such increase and decrease of the intensity of the haptic signal output by respective ones of haptic devices 102 can cause the location at which haptic devices 102 output the haptic signal to move around the diamond shape in an approximation of a circle. In contrast to the determinate haptic progress indicator, the location at which haptic devices 102 output the haptic signal may or may not move around the diamond shape approximation of a circle only once between initiation and completion of the task. Instead, the location at which haptic devices 102 output the haptic signal continues to change at a given rate during the period of time based on the duration of the task, and may repeatedly move around the diamond shape during the period of time based on the duration of the task. Hence, unlike a determinate haptic progress indicator, the location at which haptic devices 102 output the haptic signal does not correlate to progress of the task (e.g., to a percentage of completion of the task), but the haptic signal does provide an indication that performance of the task is progressing.

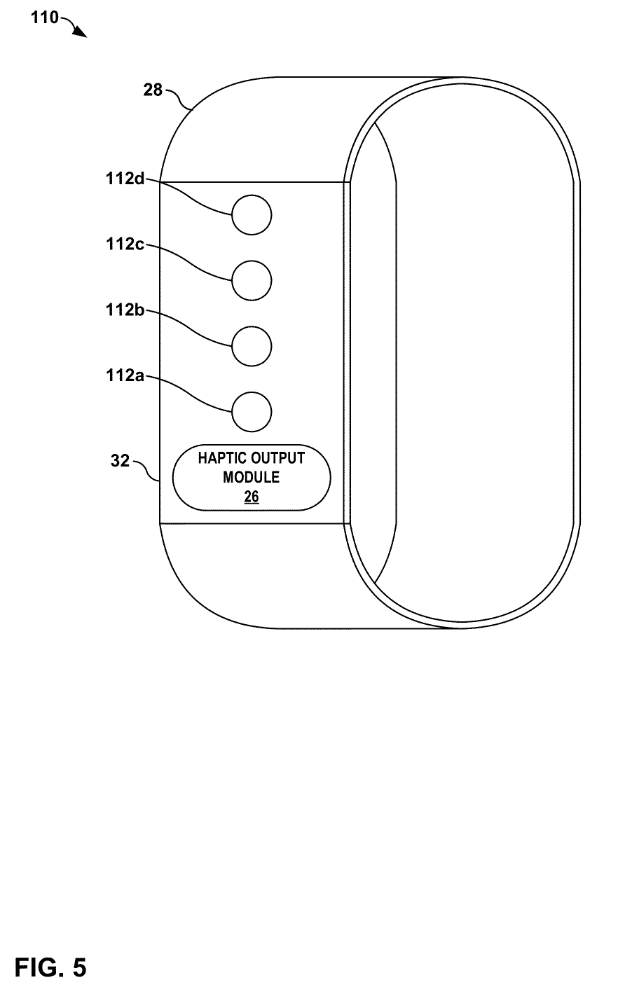

FIG. 5 is a conceptual block diagram illustrating an example mobile computing device 110 that can output, for a period of time based on a duration of a task, a haptic signal having a characteristic that indicates a progress of performance of the task, in accordance with one or more techniques of the present disclosure. FIG. 5 illustrates a simplified representation of mobile computing device 110, and omits some components of mobile computing device 110 for clarity. In some examples, mobile computing device 110 can include components similar to those described with reference to mobile computing device 20 of FIGS. 1A and 2. In other examples, mobile computing device 110 can include more or fewer components that mobile computing device 20.

As shown in FIG. 5, mobile computing device 110 includes haptic output module 26, housing 32, band 28, and four haptic devices 112a-112d (collectively, “haptic devices 112”). In the example of FIG. 5, haptic devices 112 are disposed within or attached to surface of housing 32 that faces the user when the user is wearing mobile computing device 100. In other examples, one or more of haptic devices 112 can be disposed within or attached to a surface of band 28 that faces the user when the user is wearing mobile computing device 100.

Haptic devices 112 are disposed in a linear configuration in the example of FIG. 5. As described above, haptic output module 26 can be operable to receive an indication of an input by a user, e.g., using an input device associated with or included in mobile computing device 110, instructing mobile computing device 110 to perform a task. Responsive to receiving the indication, haptic output module 26 can be operable to cause one or more of haptic devices 112 to output a haptic signal. The haptic signal can include a characteristic that indicates a progress of performance of the task by mobile computing device 110. For example, the characteristic can include a location of haptic devices 112 at which one or more of haptic devices 112 outputs the haptic signal.

For example, responsive to receiving an indication that mobile computing device 100 is initiating the task, haptic output module 26 can cause first haptic device 112a to output a haptic signal. As mobile computing device 110 progresses in performing the task, haptic output module 26 may receive periodic indications of the status of the progress. Responsive to receiving the periodic indication of the status of the progress, haptic output module 26 can change a characteristic with which one of more of haptic devices 112 outputs a haptic signal to cause the location at which the haptic signal is output to change. For example, as haptic output module 26 receives indications of progress of the task between 0% and 33% of the task, haptic output module 26 can cause the intensity with which first haptic output device 112a outputs the haptic signal to decrease, while causing the intensity with which second haptic output device 112b outputs the haptic signal to increase.

Similarly, haptic output module 26 can be operable to cause second haptic device 112b and third haptic device 112c to modify the haptic signal responsive to receiving indications of progress of the task between 33% and 66%, and to cause third haptic device 112c and fourth haptic device 112d to modify the haptic signal responsive to receiving indications of progress of the task between 66% and 100%. This may cause the location at which the haptic signal is output to appear to change substantially continuously between the location of first haptic device 112a and fourth haptic device 112d. In this way, as mobile computing device 110 progresses in performing the task from 0% to 100%, the location at which the haptic signal is output by haptic devices 112 can change in a linear manner from first haptic device 112a to fourth haptic device 112d. Additionally, the movement of the haptic signal along the line of haptic devices 112 correlates to progress of mobile computing device 110 in performing the task.

In other examples, the haptic signal may include an indeterminate haptic progress indicator. As described above, change of the characteristic indicative of progress of the task for an indeterminate haptic progress indicator does not correlate to an extent of progress of the task, but movement of the haptic progress indicator indicates that the task is being performed. For example, responsive to receiving an indication that mobile computing device 110 is initiating the task, haptic output module 26 can cause haptic devices 112 to individually and in a synchronized manner increase and decrease an intensity of the haptic signal generated by the respective haptic device 112a-112d. As described above with respect to the determinate haptic progress indicator, if timed properly, such increase and decrease of the intensity of the haptic signal output by respective ones of haptic devices 112 can cause the location at which haptic devices 112 output the haptic signal to move between adjacent haptic devices 112. In contrast to the determinate haptic progress indicator, the location at which haptic devices 112 output the haptic signal may or may not move along the line of haptic devices 112 only once between initiation and completion of the task. Instead, the location at which haptic devices 112 output the haptic signal continues to change at a given rate for the period of time based on the duration of the task. For example, the location at which haptic devices 112 output the haptic signal may change periodically from first haptic device 112a to second haptic device 112b to third haptic device 102c to fourth haptic device 102d to third haptic device 102c to second haptic device 102a, etc. In such an example, the haptic signal can pulse from the location of first haptic device 102a to the location of fourth haptic device 102d and band to the location of first haptic device 102a substantially continually for the period of time based on the duration of the task being performed by mobile computing device 110. Hence, unlike a determinate haptic progress indicator, the location at which haptic devices 112 output the haptic signal does not correlate to progress of the task, but the haptic signal does provide an indication that mobile computing device 110 is performing the task.

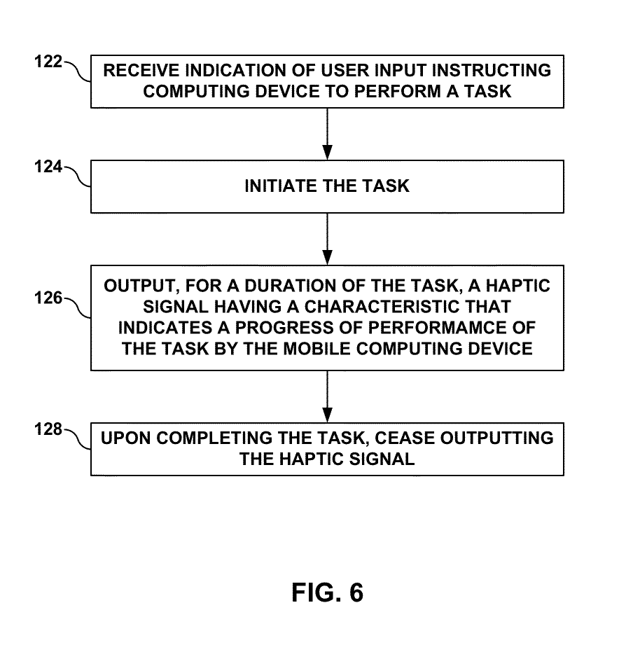

FIG. 6 is a flow diagram illustrating an example technique for outputting, for a period of time based on a duration of a task, a haptic signal having a characteristic that indicates a progress of performance of the task, in accordance with one or more techniques of the present disclosure. The technique of FIG. 6 may be performed by a computing device 60, e.g., one or more processors 40 of mobile computing device 20 illustrated in FIG. 1A and FIG. 2, one or more processors of mobile computing device 100 of FIG. 4, and/or one or more processors of mobile computing device 110 of FIG. 5. For purposes of illustration, the technique of FIG. 6 is described below within the context of computing device 20 of FIG. 1A and FIG. 2, although the technique of FIG. 6 may be performed by computing devices having configurations different than that of mobile computing device 20.

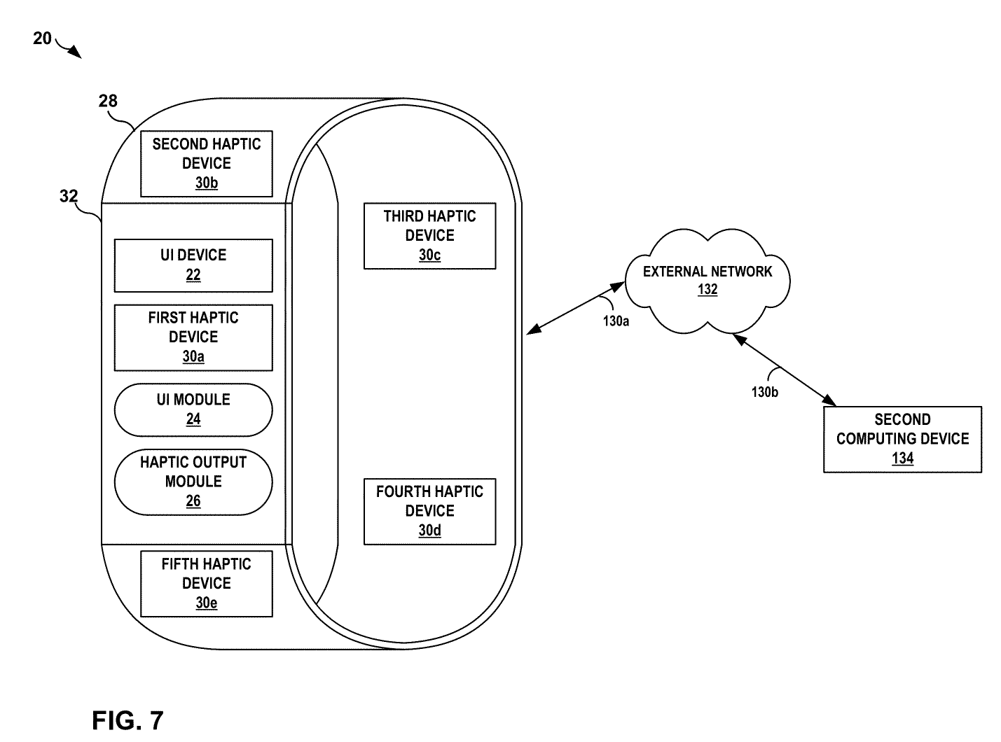

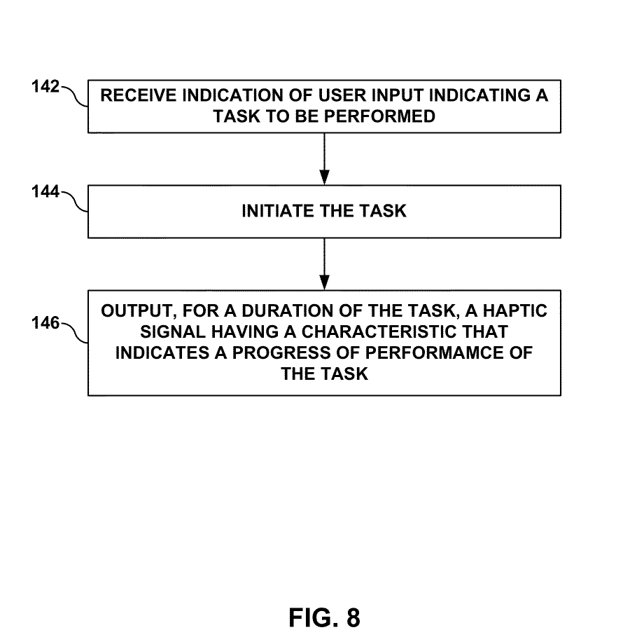

The technique of FIG. 6 includes receiving, by haptic output module 26, an indication of user input instructing mobile computing device 20 (or one or more processors 40 of mobile computing device 20) to perform a task (122). For example, UI module 24 can receive an indication of a user input, e.g., at one or more input devices 42 and/or UI device 22, instructing one or more processors 40 to perform a task. UI module 24 can be operable to communicate an indication of the instruction to haptic output module 26, which receives the indication (122). Additionally, responsive to receiving the indication of the user input, UI module 24 can cause one or more processors 40 to initiate the task (124). In some examples, as described below with reference to FIGS. 7 and 8, initiating the task (124) can include transmitting an indication to another computing device to perform the task.

In response to receiving the indication of the instruction, haptic output module 26 can cause one or more of haptic devices 30 to output, for a period of time based on a duration of the task, a haptic signal having a characteristic that indicates a progress of performance of the task by mobile computing device 20 (126). The characteristic of the haptic signal can include, for example, a location of one or more haptic devices 30 at which one or more of haptic devices 30 outputs the haptic signal, an intensity of the haptic signal, a pulse duration of the haptic signal, a frequency of the haptic signal, or the like. In some examples, two or more characteristics of the haptic signal can indicate progress of performance of the task, and can be changed by haptic output module 26 to represent progress of the task.

The technique of FIG. 6 also includes, upon completing the task, ceasing, by haptic devices 30, to output the haptic signal (128). As haptic output module 26 causes at least one of haptic devices 30 to output the haptic signal for the period of time based on the duration of the task, once mobile computing device 20 completes performance of the task, haptic output module 26 can be operable to cause the at least one of haptic devices 30 to cease outputting the haptic signal (128). In some examples, cessation of the haptic signal can indicate that mobile computing device 20 has completed performing the task. By outputting, for a period of time based on a duration of a task, a haptic signal that includes a characteristic that indicates a progress of performance of the task, mobile computing device 20 can allow a user to monitor a progress of the task without looking at a display associated with or coupled to the mobile computing device 20.

Although in some of the foregoing examples, the techniques have been described as including receiving an indication of user input instructing mobile computing device 20 to perform a task, in some examples, the user input may instruct another computing device to perform the task, or may not specify which computing device is to perform the task. For example, the user input may simply indicate a task (e.g., a computing task) to be performed. FIG. 7 is a conceptual block diagram illustrating an example mobile computing device that transmits, to a second computing device, an indication of an instruction of user input indicating a task to be performed. Example operation of the system depicted in FIG. 7 will be described with concurrent reference to the flow diagram illustrated in FIG. 8. FIG. 8 is a flow diagram illustrating example techniques for outputting, for a period of time based on a duration of a task, a haptic signal having a characteristic that indicates a progress of performance of a task, in accordance with one or more techniques of the present disclosure. The technique of FIG. 8 may be performed by one a computing device 60, such as one or more processors 40 of mobile computing device 20 illustrated in FIGS. 1A, 2, and 7, one or more processors of mobile computing device 100 of FIG. 4, one or more processors of mobile computing device 110 of FIG. 5, and/or second computing device 134 of FIG. 7. For purposes of illustration, the technique of FIG. 8 is described below within the context of mobile computing device 20 and second computing device 134 of FIG. 7, although the technique of FIG. 8 may be performed by computing devices having configurations different than that of mobile computing device 20 and second computing device 134.

As shown in FIG. 7, mobile computing device 20 may be similar to or substantially the same as mobile computing device 20 of FIGS. 1A and 2. In other examples, mobile computing device 20 may include fewer or additional components than those shown in FIG. 7. Regardless of the configuration of mobile computing device 20, mobile computing device 20 includes at least one haptic device 30 and a haptic output module 26.

In some examples, mobile computing device 20 may send and receive data using any suitable communication techniques. For example, mobile computing device 20 may be operatively coupled to external network 132 using network link 130a. Similarly, second computing device 134 may be operatively coupled to external network 132 using network link 130b. External network 134 may include network hubs, network switches, network routers, etc., that are operatively inter-coupled thereby providing for the exchange of information between mobile computing device 20 and the remote devices illustrated in FIG. 7. In some examples, network links 130a and 130b may be Ethernet, ATM or other network connections. Such connections may be wireless and/or wired connections.

In some examples, mobile computing device 20 may be operatively coupled second computing device 134 using direct device communication (not shown in FIG. 7). Direct device communication may include communications through which mobile computing device 20 sends and receives data directly with second computing device 134, using wired or wireless communication. That is, in some examples of direct device communication, data sent by mobile computing device 20 may not be forwarded by one or more additional devices before being received at second computing device 134, and vice-versa. Examples of direct device communication techniques may include Bluetooth, Near-Field Communication, Universal Serial Bus, infrared, etc. Such connections may be wireless and/or wired connections.

Second computing device 134 may include any type of other computing device physically separate from mobile computing device 20. For example, second computing device 134 may include a server, a workstation, a desktop computer, a laptop computer, a tablet computer, another mobile computing device, or the like.

As shown in FIG. 8, a technique may include receiving, by mobile computing device 20 (e.g., one or more of processors 40 (FIG. 2)), an indication of user input indicating a task to be performed (142). For example, UI module 24 can receive an indication of a user input, e.g., at one or more input devices 42 and/or UI device 22, indicating a task to be performed. In some examples, the indication of the task to be performed may include an indication of the device which is to perform the task, e.g., one of mobile computing device 20 and second computing device 134. In other examples, the indication of the task to be performed may not include an indication of the device which is to perform the task. Mobile computing device 20, e.g., operating system 50 or an application executed by one or more processors 40, may include instructions indicating which computing device is to perform specified tasks, e.g., whether mobile computing device 20 performs the task or second computing device 134 performs the task.

Based at least in part on the task indicated to be performed, one or more processors 40 may initiate the task (144). In some examples in which mobile computing device 20 performs the specified task, initiating the task (144) can include beginning performance of the task, e.g., by one or more processors 40. An example technique proceeding according to this aspect of the technique of FIG. 8 is illustrated and described above with respect to FIG. 6.

In examples in which second computing device 134 performs the specified task, initiating the task (144) can include transmitting, by one or more processors 40, using one or more communication units 44, to second computing device 134, an indication of the task to be performed. The indication may include an indication of the task and, in some examples, associated information used by second computing device 134 to perform the task. For example, when the task is a voice search and the voice-to-text and/or search query is performed by second computing device 134 (e.g., a server), the indication can include the indication of the task to be performed and data representing the audio input.

Additionally, an indication of the user input can be received by haptic output module 26 (e.g., from UI module 24). In response to receiving the indication of the instruction, haptic output module 26 can cause one or more of haptic devices 30 to output, for a period of time based on a duration of the task, a haptic signal having a characteristic that indicates a progress of performance of the task (146). The characteristic of the haptic signal can include, for example, a location of at least one haptic device 30 at which one or more of haptic devices 30 outputs the haptic signal, an intensity of the haptic signal, a pulse duration of the haptic signal, a frequency of the haptic signal, or the like. In some examples, two or more characteristics of the haptic signal can indicate progress of performance of the task, and can be changed by haptic output module 26 to represent progress of the task.

In some examples, mobile computing device 20 can receive, from second computing device 134, periodic or aperiodic indications of progress of performance of the task. In some examples, mobile computing device 20 (e.g., haptic output module 26) can control the characteristic of the haptic signal based at least in part on these occasional status updates. In other examples, haptic output module 26 can store (e.g., in one or more storage devices 48) estimates of time needed to complete the task, and may control the characteristic of the haptic signal based at least in part on the estimated time. Additionally or alternatively, mobile computing device 20 can receive, from second computing device 134, an indication that second computing device 134 has completed the task. In response to receiving the indication that second computing device 134 has completed the task, haptic output module 26 can cause haptic devices 30 to cease outputting the haptic signal. In this way, mobile computing device 20 can output, for a period of time based on a duration of a task, a haptic signal that includes a characteristic that indicates a progress of performance of the task, whether the task is performed locally by mobile computing device 20, remotely by a second computing device 134, or by a combination of mobile computing device 20 and second computing device 134.

Clause 1. A method comprising receiving, by a computing device, an indication of user input indicating a task to be performed; initiating, by the computing device, the task; and causing, by the computing device, at least one haptic device operatively coupled to the computing device to output, for a period of time based on a duration of the task, a haptic signal having a characteristic that indicates a progress of performance of the task.

Clause 2. The method of clause 1, wherein the characteristic of the haptic signal that represents a progress of the performance of the task comprises a current location of the at least one haptic device at which the at least one haptic device outputs the haptic signal, and wherein causing the at least one haptic device operatively coupled to the computing device to output the haptic signal comprises causing the at least one haptic device to modify the current location of the at least one haptic device at which the at least one haptic device outputs the haptic signal during the performance of the task to represent progress of the task.

Clause 3. The method of clause 2, wherein modifying the current location of the at least one haptic device at which the at least one haptic device outputs the haptic signal comprises modifying the current location of the at least one haptic device at which the at least one haptic device outputs the haptic signal from a first location of the at least one haptic device at initiation of the task to a second location of the at least one haptic device at completion of the task.

Clause 4. The method of clause 2, wherein modifying the current location of the at least one haptic device at which the at least one haptic device outputs the haptic signal comprises periodically changing the current location of the at least one haptic device at which the at least one haptic device outputs the haptic signal among a plurality of locations of the at least one haptic device while the task is being performed.

Clause 5. The method of any of clauses 1 to 4, wherein the characteristic of the haptic signal comprises at least one of an intensity, a frequency, and a pulse duration of the haptic signal, and wherein causing the at least one haptic device operatively coupled to the computing device to output the haptic signal comprises causing the at least one haptic device operatively coupled to the computing device to modify the at least one of the intensity, the frequency, and the pulse duration to represent progress of the task.

Clause 6. The method of any of clauses 1 to 5, wherein the at least one haptic device is included within a band of a wearable computing device, and wherein the at least one haptic device comprises a plurality of haptic devices disposed at different locations of the band.

Clause 7. The method of clause 6, wherein causing the at least one haptic device operatively coupled to the computing device to output, for the period of time based on the duration of the task, the haptic signal comprises causing the plurality of haptic devices to output the haptic signal sequentially at the different locations of the band as the performance of the task progresses.

Clause 8. The method of any of clauses 1 to 7, wherein the computing device comprises a first computing device, wherein initiating the task comprises transmitting, by the first computing device, to a second computing device, an indication that causes the second computing device to perform the task, further comprising receiving, by the first computing device, from the second computing device, an indication that the second computing device has completed the task.

Clause 9. The method of any of clauses 1 to 7, wherein initiating the task comprises beginning, by the computing device, performance of the task.

Clause 10. A mobile computing device comprising one or more processors; one or more haptic devices; a user interface module operable by the one or more processors to receive an indication of user input indicating a task to be performed, and, responsive to the indication, cause the task to be performed; and a haptic output module operable by the one or more processors to cause at least one haptic device of the one or more haptic devices to output, for a period of time based on a duration of the task, a haptic signal having a characteristic that indicates a progress of performance of the task, wherein the characteristic of the haptic signal that represents a progress of the performance of the task comprises a current location of the at least one haptic device at which the at least one haptic device outputs the haptic signal, and wherein the haptic output module causes the at least one haptic device of the one or more haptic devices to modify the current location of the at least one haptic device at which the at least one haptic device outputs the haptic signal during the performance of the task to represent progress of the task.

Clause 11. The mobile computing device of clause 10, wherein the haptic output module is operable by the one or more processors to cause the at least one haptic device to modify the current location of the at least one haptic device at which the at least one haptic device outputs the haptic signal from a first location of the at least one haptic device to a second location of the at least one haptic device during the performance of the task to represent progress of the task.

Clause 12. The mobile computing device of clause 10, wherein the haptic output module is operable by the one or more processors to cause the at least one haptic device to modify the current location of the at least one haptic device at which the at least one haptic device outputs the haptic signal periodically among a plurality of locations of the at least one haptic device during the performance of the task to represent progress of the task.

Clause 13. The mobile computing device of any of clauses 10 to 12, wherein the characteristic of the haptic signal further comprises at least one of an intensity, a frequency, and a pulse duration of the haptic signal, and wherein the haptic output module is operable by the one or more processors to cause the at least one haptic device of the one or more haptic devices to modify the at least one of the intensity, the frequency, and the pulse duration of the haptic signal to represent progress of the task.

Clause 14. The mobile computing device of any of clauses 10 to 13, wherein the mobile computing device comprises a wearable computing device, wherein the wearable computing device further comprises a band, wherein the band comprises the at least one haptic device, and wherein the at least one haptic device comprises a plurality of haptic devices disposed at different locations of the band.

Clause 15. The mobile computing device of clause 14, wherein the haptic output module is operable to cause the plurality of haptic devices to output haptic signal sequentially at the different locations of the band as the performance of the task progresses.

Clause 16. The mobile computing device of any of clauses 10 to 15, further comprising one or more communication units, wherein the user interface module is operable by the one or more processors to transmit, using the one or more communication units, to a second computing device, an indication that causes the second computing device to perform the task, and wherein the haptic output module is further operable by the one or more processors to receive, from the second computing device, an indication that the second computing device has completed the task.

Clause 17. The mobile computing device of any of clauses 10 to 15, wherein the user interface module is operable by the one or more processors to cause the one or more processors to begin performing the task.

Clause 18. A computer-readable storage device storing instructions that, when executed, cause at least one processor of a mobile computing device to receive an indication of user input indicating a task to be performed; initiate the task; cause at least one haptic device associated with the mobile computing device to output, for a period of time based on a duration of the task, a haptic signal having a characteristic that indicates a progress of performance of the task; and upon completion of the task, cause the at least one haptic device to cease producing the haptic signal.

Clause 19. The computer-readable storage device of clause 18, wherein the characteristic of the haptic signal that represents a progress of the performance of the task comprises a current location of the at least one haptic device at which the at least one haptic device outputs the haptic signal, and wherein the instructions that cause the at least one processor to cause the at least one haptic device associated with the mobile computing device to output the haptic signal comprise instructions that cause the at least one processor to cause the at least one haptic device to modify the current location of the at least one haptic device at which the at least one haptic device outputs the haptic signal during the performance of the task to represent progress of the task.

Clause 20. The computer-readable storage device of clause 18, wherein the instructions that cause the at least one processor to cause the at least one haptic device to modify the current location of the at least one haptic device at which the at least one haptic device outputs the haptic signal comprise instructions that cause the at least one processor to cause the at least one haptic device to modify the current location of the at least one haptic device at which the at least one haptic device outputs the haptic signal from a first location of the at least one haptic device at initiation of the task to a second location of the at least one haptic device at completion of the task.

Clause 21. The computer-readable storage device of clause 18, wherein the instructions that cause the at least one processor to cause the at least one haptic device to modify the current location of the at least one haptic device at which the at least one haptic device outputs the haptic signal comprise instructions that cause the at least one processor to cause the at least one haptic device to periodically change the current location of the at least one haptic device at which the at least one haptic device outputs the haptic signal among a plurality of locations of the at least one haptic device while the task is being performed.

Clause 22. The computer-readable storage device of any of clauses 18 to 21, wherein the characteristic of the haptic signal comprises at least one of an intensity, a frequency, and a pulse duration of the haptic signal, and wherein the instructions that cause the at least one processor to cause the at least one haptic device associated with the mobile computing device to output the haptic signal comprise instructions that cause the at least one processor to cause the at least one haptic device associated with the mobile computing device to modify the at least one of the intensity, the frequency, and the pulse duration to represent progress of the task.

Clause 23. The computer-readable storage device of any of clauses 18 to 22, wherein the mobile computing device comprises a wearable computing device, wherein the wearable computing device further comprises a band, wherein the band comprises the at least one haptic device, and wherein the at least one haptic device comprises a plurality of haptic devices disposed at different locations of the band.

Clause 24. The computer-readable storage device of clause 23, wherein the instructions that cause the at least one processor to output the instruction to cause the at least one haptic device associated with the mobile computing device to output the haptic signal comprise instructions that cause the at least one processor to output an instruction to cause the plurality of haptic devices to output haptic signal sequentially at the different locations of the band as the performance of the task by the wearable computing device progresses.

Clause 25. The computer-readable storage device of any of clauses 18 to 24, wherein the instructions that cause the at least one processor to initiate the task cause the at least one processor to transmit, using one or more communication units of the mobile computing device, to a second computing device, an indication that causes the second computing device to perform the task, and further comprising instructions that, when executed, cause the at least one processor to receive, from the second computing device, an indication that the second computing device has completed the task.

Clause 26. The computer-readable storage device of any of clauses 18 to 24, wherein the instructions that cause the at least one processor to initiate the task cause the at least one processor to begin performing the task.

In one or more examples, the functions described herein may be implemented in hardware, software, firmware, or any combination thereof. If implemented in software, the functions may be stored on or transmitted over, as one or more instructions or code, a computer-readable medium or computer-readable storage device and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media or computer-readable storage device, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method comprising:
receiving, by a computing device, an indication of user input indicating a task to be performed;
initiating, by the computing device, the task; and
responsive to initiating the task, causing, by the computing device, at least one haptic device operatively coupled to the computing device to output, for a period of time based on a duration of the task, a haptic signal having a characteristic that indicates a progress of performance of the task.

2. The method of claim 1, wherein
the characteristic of the haptic signal that represents a progress of the performance of the task comprises a current location of the at least one haptic device at which the at least one haptic device outputs the haptic signal, and
causing the at least one haptic device operatively coupled to the computing device to output the haptic signal comprises causing the at least one haptic device to modify the current location of the at least one haptic device at which the at least one haptic device outputs the haptic signal during the performance of the task to represent progress of the task.

3. The method of claim 2, wherein modifying the current location of the at least one haptic device at which the at least one haptic device outputs the haptic signal comprises modifying the current location of the at least one haptic device at which the at least one haptic device outputs the haptic signal from a first location of the at least one haptic device at initiation of the task to a second location of the at least one haptic device at completion of the task.

4. The method of claim 2, wherein modifying the current location of the at least one haptic device at which the at least one haptic device outputs the haptic signal comprises periodically changing the current location of the at least one haptic device at which the at least one haptic device outputs the haptic signal among a plurality of locations of the at least one haptic device while the task is being performed.

5. The method of claim 1, wherein
the characteristic of the haptic signal comprises at least one of an intensity, a frequency, and a pulse duration of the haptic signal, and
causing the at least one haptic device operatively coupled to the computing device to output the haptic signal comprises causing the at least one haptic device operatively coupled to the computing device to modify the at least one of the intensity, the frequency, and the pulse duration to represent progress of the task.

6. The method of claim 1, wherein
the at least one haptic device is included within a band of a wearable computing device, and
the at least one haptic device comprises a plurality of haptic devices disposed at different locations of the band.

7. The method of claim 6, wherein causing the at least one haptic device operatively coupled to the computing device to output, for the period of time based on the duration of the task, the haptic signal, comprises causing the plurality of haptic devices to output the haptic signal sequentially at the different locations of the band as the performance of the task progresses.

8. The method of claim 1, wherein
the computing device comprises a first computing device, and
initiating the task comprises transmitting, by the first computing device, to a second computing device, an indication that causes the second computing device to perform the task, further comprising:
receiving, by the first computing device, from the second computing device, an indication that the second computing device has completed the task.

9. The method of claim 1, wherein initiating the task comprises beginning, by the computing device, performance of the task.

10. A mobile computing device comprising:
one or more processors;
one or more haptic devices;
a user interface module operable by the one or more processors to receive an indication of user input indicating a task to be performed, and, responsive to the indication, cause the task to be performed; and
a haptic output module operable by the one or more processors to, responsive to causing the task to be performed, cause at least one haptic device of the one or more haptic devices to output, for a period of time based on a duration of the task, a haptic signal having a characteristic that indicates a progress of performance of the task,
wherein the characteristic of the haptic signal that represents a progress of the performance of the task comprises a current location of the at least one haptic device at which the at least one haptic device outputs the haptic signal, and
wherein the haptic output module causes the at least one haptic device of the one or more haptic devices to modify the current location of the at least one haptic device at which the at least one haptic device outputs the haptic signal during the performance of the task to represent progress of the task.

11. The mobile computing device of claim 10, wherein the haptic output module is operable by the one or more processors to cause the at least one haptic device to modify the current location of the at least one haptic device at which the at least one haptic device outputs the haptic signal from a first location of the at least one haptic device to a second location of the at least one haptic device during the performance of the task to represent progress of the task.

12. The mobile computing device of claim 10, wherein the haptic output module is operable by the one or more processors to cause the at least one haptic device to modify the current location of the at least one haptic device at which the at least one haptic device outputs the haptic signal periodically among a plurality of locations of the at least one haptic device during the performance of the task to represent progress of the task.

13. The mobile computing device of claim 10, wherein
the characteristic of the haptic signal further comprises at least one of an intensity, a frequency, and a pulse duration of the haptic signal, and
the haptic output module is operable by the one or more processors to cause the at least one haptic device of the one or more haptic devices to modify the at least one of the intensity, the frequency, and the pulse duration of the haptic signal to represent progress of the task.

14. The mobile computing device of claim 10, wherein
the mobile computing device comprises a wearable computing device, wherein the wearable computing device further comprises a band,
the band comprises the at least one haptic device, and
the at least one haptic device comprises a plurality of haptic devices disposed at different locations of the band.

15. The mobile computing device of claim 14, wherein the haptic output module is operable to cause the plurality of haptic devices to output haptic signal sequentially at the different locations of the band as the performance of the task progresses.

16. The mobile computing device of claim 10, further comprising one or more communication units, wherein the user interface module is operable by the one or more processors to transmit, using the one or more communication units, to a second computing device, an indication that causes the second computing device to perform the task, and wherein the haptic output module is further operable by the one or more processors to receive, from the second computing device, an indication that the second computing device has completed the task.

17. The mobile computing device of claim 10, wherein the user interface module is operable by the one or more processors to cause the one or more processors to begin performing the task.

18. A non-transitory computer-readable storage device storing instructions that, when executed, cause at least one processor of a mobile computing device to:
receive an indication of user input indicating a task to be performed;
initiate the task;
responsive to initiating the task, cause at least one haptic device associated with the mobile computing device to output, for a period of time based on a duration of the task, a haptic signal having a characteristic that indicates a progress of performance of the task; and
upon completion of the task, cause the at least one haptic device to cease producing the haptic signal.

19. The non-transitory computer-readable storage device of claim 18, wherein
the characteristic of the haptic signal that represents a progress of the performance of the task comprises a current location of the at least one haptic device at which the at least one haptic device outputs the haptic signal, and
the instructions that cause the at least one processor to cause the at least one haptic device associated with the mobile computing device to output the haptic signal comprise instructions that cause the at least one processor to cause the at least one haptic device to modify the current location of the at least one haptic device at which the at least one haptic device outputs the haptic signal during the performance of the task to represent progress of the task.

20. The non-transitory computer-readable storage device of claim 18, wherein the instructions that cause the at least one processor to cause the at least one haptic device to modify the current location of the at least one haptic device at which the at least one haptic device outputs the haptic signal comprise instructions that cause the at least one processor to cause the at least one haptic device to modify the current location of the at least one haptic device at which the at least one haptic device outputs the haptic signal from a first location of the at least one haptic device at initiation of the task to a second location of the at least one haptic device at completion of the task.

21. The non-transitory computer-readable storage device of claim 18, wherein the instructions that cause the at least one processor to cause the at least one haptic device to modify the current location of the at least one haptic device at which the at least one haptic device outputs the haptic signal comprise instructions that cause the at least one processor to cause the at least one haptic device to periodically change the current location of the at least one haptic device at which the at least one haptic device outputs the haptic signal among a plurality of locations of the at least one haptic device while the task is being performed.

22. The non-transitory computer-readable storage device of claim 18, wherein the characteristic of the haptic signal comprises at least one of an intensity, a frequency, and a pulse duration of the haptic signal, and wherein the instructions that cause the at least one processor to cause the at least one haptic device associated with the mobile computing device to output the haptic signal comprise instructions that cause the at least one processor to cause the at least one haptic device associated with the mobile computing device to modify the at least one of the intensity, the frequency, and the pulse duration to represent progress of the task.

23. The non-transitory computer-readable storage device of claim 18, wherein the mobile computing device comprises a wearable computing device, wherein the wearable computing device further comprises a band, wherein the band comprises the at least one haptic device, and wherein the at least one haptic device comprises a plurality of haptic devices disposed at different locations of the band.

24. The non-transitory computer-readable storage device of claim 23, wherein the instructions that cause the at least one processor to output the instruction to cause the at least one haptic device associated with the mobile computing device to output the haptic signal comprise instructions that cause the at least one processor to output an instruction to cause the plurality of haptic devices to output haptic signal sequentially at the different locations of the band as the performance of the task by the wearable computing device progresses.

25. The non-transitory computer-readable storage device of claim 18, wherein the instructions that cause the at least one processor to initiate the task cause the at least one processor to transmit, using one or more communication units of the mobile computing device, to a second computing device, an indication that causes the second computing device to perform the task, and further comprising instructions that, when executed, cause the at least one processor to receive, from the second computing device, an indication that the second computing device has completed the task.

26. The non-transitory computer-readable storage device of claim 18, wherein the instructions that cause the at least one processor to initiate the task cause the at least one processor to begin performing the task.
